(19) United States
(12) Patent Application Publication
(10) Pub. No.: US 2005/0266274 A1
(43) Pub. Date: Dec. 1, 2005

(54) Magnetic sensor using half-metal for pinned magnetic layer

(75) Inventors: Naoya Hasegawa, Tokyo (JP); Masamichi Saito, Tokyo (JP); Yosuke Ide, Tokyo (JP); Masahiko Ishizone, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/142,755

(22) Filed: Jun. 1, 2005

(30) Foreign Application Priority Data
Jun. 1, 2004 (JP) 2004-163698

(51) Int. Cl. G11B 5/66

(52) U.S. Cl. 428/828

(57) ABSTRACT

When a pinned magnetic layer includes an underlayer and a Heusler alloy layer, a product ΔR×A of the amount of change in resistance and an element surface area of a magnetic sensor per unit area is increased. That is, a magnetic field detection sensitivity of the magnetic sensor can be improved. It is believed that the magnetic field detection sensitivity of the magnetic sensor is improved by the present invention because a misfit percentage between the underlayer and the Heusler alloy layer is small, and therefore the crystallinity or the periodicity of the Heusler alloy layer is improved.

This application claims the benefit of priority to Japanese Patent Application No. 2004-163698, which was filed on Jun. 1, 2004, and which is incorporated herein by reference.

### TECHNICAL FIELD

The present application relates to a magnetic sensor, and more particularly, to a magnetic sensor having a pinned magnetic layer in which a magnetization direction is pinned in one direction and a free magnetic layer provided for the pinned magnetic layer with a non-magnetic material layer interposed therebetween.

### BACKGROUND

Magnetic sensors that utilize the giant magnetoresistive (GMR) effect to detect a magnetic field from a recording medium, such as a hard disk or the like, may have a spin valve thin film structure. This structure includes an antiferromagnetic layer, a pinned magnetic layer, a nonmagnetic intermediate layer, and a free magnetic layer. The magnetization direction of the pinned magnetic layer is determined by exchange coupling with the antiferromagnetic layer, and the magnetization direction of the free magnetic layer rotates in response to the detected magnetic field. The resistance of the spin valve thin film element varies depending on the relative magnetization directions of the pinned layer and the free layer. Because small magnetic fields can be detected by a spin valve thin film element, it is advantageous for magnetic recording. Such a magnetic sensor is shown in FIG. 10 in a partial cross-sectional view taken along the direction parallel to a surface facing a recording medium.

Reference numeral 1 in FIG. 10 indicates an underlayer formed of Ta, and on the underlayer 1, a seed layer 2 is provided which is made of a metal, such as Cr, having a bcc (body-centered cubic) structure.

On the seed layer 2, a free magnetic layer 3, a non-magnetic material layer 4, a pinned magnetic layer 5, an antiferromagnetic layer 6, and a protective layer 7 are provided in that order from the bottom to form a multilayer film T.

The free magnetic layer 3, the non-magnetic material layer 4, the antiferromagnetic layer 6, and the protective layer 7 are formed of NiFe, Cu, PtMn, and Ta, respectively, and the pinned magnetic layer 5 is formed of a Heusler alloy such as Co₂MoAl.

“Heusler alloy” is a generic name of a metal compound which has a Heusler's crystal structure and, depending on the composition thereof, exhibits ferromagnetism. Some kinds of the Heusler alloys behave as a metal having a large spin polarizability and as a half-metal in which nearly all d-electrons and f-electrons around Fermi-level are composed only of spin-up electrons or spin-down electrons.

An exchange coupling magnetic field is generated at the interface between the antiferromagnetic layer 6 and the pinned magnetic layer 5, and as a result, the magnetization of the pinned magnetic layer 5 is pinned in a height direction (Y direction in the figure).

At two sides of the free magnetic layer 3, hard bias layers 8 made of a hard magnetic material such as CoPt are formed, and the top, the bottom, and the end of each of the hard bias layers 8 are insulated by an insulating layer 9. By a longitudinal bias magnetic field from the hard bias layers 8, the magnetization of the free magnetic layer 3 is aligned in a track width direction (X direction in the figure).

When an external magnetic field is applied to the magnetic sensor shown in FIG. 10, the magnetization direction of the free magnetic layer changes relative to the magnetization direction of the pinned magnetic layer, and as a result, the resistance of the multilayer film is changed. This change in the resistance of the multilayer film is detected as a voltage change, and the external magnetic field is thereby detected.

A magnetic sensor having a pinned layer made of a Heusler alloy has been disclosed in Japanese Unexamined Patent Application Publication No. 2003-309305 (page 8 and FIG. 4).

In the above Unexamined Patent Application Publication, a magnetic sensor is described as having a pinned magnetic layer which has a laminate structure formed from a magnetic layer made of a Heusler alloy and a magnetic layer made of a CoFe alloy.

However, in the above Unexamined Patent Application Publication, the composition and the crystal structure of the CoFe alloy are not described. That is, in the above Unexamined Patent Application Publication, no consideration was given to the appropriate design of the composition and the crystal structure of the CoFe alloy provided on the Heusler alloy in order to improve the magnetic field detection performance of the magnetic sensor.

### SUMMARY

A magnetic sensor which uses a half-metal alloy for a p inned magnetic layer and which can improve a magnetic field detection performance is described.

A “half-metal alloy” is defined as a magnetic alloy that behaves as a metal for one type of spin conduction electron and also behaves as an insulator for the other type of spin conduction electron.

In one embodiment, a magnetic sensor includes at least one pinned magnetic layer in which the magnetization direction is pinned in one direction; and a free magnetic layer provided for the pinned magnetic layer with at least one non-magnetic material layer interposed therebetween. In the magnetic sensor described above, the pinned magnetic layer includes an underlayer and a half-metal alloy layer provided directly on the underlayer or provided thereabove with a layer of a non-magnetic material or a magnetic material interposed therebetween, and the underlayer is formed of a CoFe alloy having a body-centered cubic (bcc) structure and a composition formula represented by Co₁₀₀₋ₓFeₓ (where x is in the range of about 25 to about 95 atomic percent).

According to this embodiment, in forming the half-metal alloy layer as a part of the pinned magnetic layer and providing the underlayer described above under the half-metal alloy layer, the magnetic field detection sensitivity of the magnetic sensor can be improved.

In this embodiment, it is believed that the magnetic field detection sensitivity of the magnetic sensor is improved when the half-metal alloy layer is provided directly on the underlayer or provided thereabove, with the layer, which is formed of a non-magnetic material or a magnetic material, interposed therebetween, because the crystallinity or the degree of order of the half-metal alloy layer is improved.

In another embodiment, a magnetic sensor is provided including: a pinned magnetic layer in which the magnetization direction is pinned in one direction; and a free magnetic layer provided for the pinned magnetic layer with a non-magnetic material layer interposed therebetween. In the magnetic sensor described above, the pinned magnetic layer contains an underlayer and a half-metal alloy layer provided directly on the underlayer or provided thereabove, with a layer, which is formed of a non-magnetic material or a magnetic material, interposed therebetween, and a misfit percentage R between a spacing “d value a” of a primary lattice line of the half-metal alloy layer and a spacing “d value b” of a primary lattice line of the underlayer is in the range of 0% to 1.1%, the misfit percentage R being represented by R=(a−b)×100/b (%).

Also in this embodiment, when the underlayer is provided under the half-metal alloy layer in forming the half-metal alloy layer as a part of the pinned magnetic layer, the magnetic field detection sensitivity can be improved.

In this embodiment, it is believed that the magnetic field detection sensitivity of the magnetic sensor is improved when the half-metal alloy layer is provided directly on the underlayer or provided thereabove, with the layer, which is formed of a non-magnetic material or a magnetic material, interposed therebetween, because the crystallinity or the periodicity of the half-metal alloy layer is improved.

The underlayer preferably contains a CoFe alloy having a body-centered cubic (bcc) structure. In particular, the underlayer is preferably formed of Co₁₀₀₋ₓFeₓ in which x is in the range of about 25 to about 95 atomic percent.

The half-metal alloy layer preferably has a body-centered cubic (bcc) structure in which equivalent planes represented by the {220} family of planes are preferentially oriented in a direction parallel to the surface of the layer.

In addition, it is preferable that the pinned magnetic layer have a synthetic ferrimagnetic structure formed of a first pinned magnetic layer, a second pinned magnetic layer, and a non-magnetic interlayer interposed therebetween, where the second pinned magnetic layer contains the underlayer and the half-metal alloy layer provided thereon, the underlayer being located at the non-magnetic interlayer side.

Alternatively, it is preferable that the pinned magnetic layer have a synthetic ferrimagnetic structure formed of a first pinned magnetic layer, a second pinned magnetic layer, and a non-magnetic interlayer interposed therebetween, where the underlayer forms a part of the first pinned magnetic layer and is located at the non-magnetic interlayer side, and the half-metal alloy layer forms the second pinned magnetic layer.

The half-metal alloy layer preferably has an average crystal grain diameter of 50 Å or more in a direction parallel to a surface of the layer.

The half-metal alloy layer may be a Heusler alloy layer formed, for example, of a Heusler alloy.

Materials that may be used for the Heusler alloy layer are shown below by way of example.

1. A Metal Compound Having a Heusler's Crystal Structure Represented By a Composition Formula X₂YZ or XYZ

In this case, X is at least one element selected from the group consisting of Cu, Co, Ni, Rh, Pt, Au, Pd, Ir, Ru, Ag, Zn, Cd, and Fe, Y is at least one element selected from the group consisting of Mn, Fe, Ti, V, Zr, Nb, Hf, Ta, Cr, Co, and Ni, and Z is at least one element selected from the group consisting of Al, Sn, In, Sb, Ga, Si, Ge, Pb, and Zn.

2. A Metal Compound Having a Heusler's Crystal Structure Represented By a Composition Formula Co₂YZ

In this case, Y is at least one element selected from the group consisting of Mn, Fe, and Cr, and Z is at least one element selected from the group consisting of Al, Ga, Si, and Ge.

3. A Metal Compound Having a Composition Formula Represented By Co₂MnZ

In this case, Z is Si or Ge.

In addition, in this embodiment, the Heusler alloy layer may be formed of a metal compound having a composition formula represented by Co₂MnGe, and the lattice constant of the Heusler alloy layer may be in the range of about 5.7 to about 5.85 Å. When the lattice constant of the Heusler alloy layer is in the range of about 5.7 to about 5.85 Å, the Heusler alloy has the L21 structure.

The Heusler alloy layer may be formed of a metal compound having a composition formula represented by Co₂MnGe, and that the Ge concentration of this Co₂MnGe alloy may be in the range of about 20 to about 30 atomic percent.

In another aspect, the Heusler alloy layer may be formed of a metal compound having a composition formula represented by Co₂MnSi, and the lattice constant of the Heusler alloy layer may be in the range of about 5.6 to about 5.75 Å. When the lattice constant of the Heusler alloy layer is in the range of about 5.6 to about 5.75 Å, the Heusler alloy layer has the L21 structure.

The magnetic sensor described herein may further include an antiferromagnetic layer. In this case, as another embodiment of the magnetic sensor of the present invention, a single spin valve magnetoresistive element is described in which the pinned magnetic layer is formed to be in contact with this antiferromagnetic layer. The magnetization direction of the pinned magnetic layer is pinned by an exchange coupling magnetic field with the antiferromagnetic layer, and a free magnetic layer is provided for the pinned magnetic layer with a non-magnetic material layer interposed therebetween.

In a further embodiment, a dual spin valve magnetoresistive element is described in which the non-magnetic material layers are provided on the top and the bottom of the free magnetic layer, and in which the pinned magnetic layers are individually located over one of the non-magnetic material layers and under the other non-magnetic material layer. In this structure, antiferromagnetic layers may be individually provided over one of the pinned magnetic layers and under the other pinned magnetic layer so that the magnetization directions of each of the pinned magnetic layers are pinned in a predetermined direction.

The present embodiment may be applied to a CPP (current perpendicular to the plane)-GMR magnetic sensor and a CPP-TMR (tunnel effect magnetoresistive element). In the CPP-GMR sensor, a sensing current flows in the direction perpendicular to surfaces of the pinned magnetic layer, the non-magnetic material layer, and the free magnetic layer.

When a Heusler alloy is used as a material for the free magnetic layer or the pinned magnetic layer of a CPP-GMR or a CPP-TMR magnetic sensor, the amount of change in spin diffusion length or mean free path of a conduction electron in the magnetic sensor is increased due to the change in spin-dependent bulk scattering before and after the application of an external magnetic field. That is, the amount of change in the resistance of the multilayer film is increased, and as a result, the detection sensitivity of the magnetic sensor to an external magnetic field is improved.

When the underlayer is provided under the Heusler alloy layer in forming the Heusler alloy layer as a part of the pinned magnetic layer, the magnetic field detection sensitivity of the magnetic sensor can be improved.

The underlayer may be formed of a CoFe alloy having a body-centered cubic (bcc) structure and a composition formula represented by Co₁₀₀₋ₓFeₓ (where x is in the range of about 25 to about 95 atomic percent).

In addition, when the underlayer is formed so that the misfit percentage R obtained from a spacing “d value a” (hereinafter referred to as a “d value a”) of a primary lattice line of the Heusler alloy layer and a spacing “d value b” (hereinafter referred to as a “d value b”) of a primary lattice line of the underlayer is in the range of 0% to 1.1%, the magnetic field detection sensitivity of the magnetic sensor can be improved. In this case, the misfit percentage R can be represented by R=(a−b)×100/b (%).

### BRIEF DESCRIPTION OF THE DRAWINGS

FIG. 1 is a cross-sectional view showing the structure of a magnetic sensor (single spin valve magnetoresistive element) of a first embodiment, which is viewed from a surface facing a recording medium;

FIG. 2 is a cross-sectional view showing the structure of a magnetic sensor (single spin valve magnetoresistive element) of a second embodiment, which is viewed from a surface facing a recording medium;

FIG. 3 is a cross-sectional view showing the structure of a magnetic sensor (dual spin valve magnetoresistive element) of a third embodiment, which is viewed from a surface facing a recording medium;

FIG. 4 is a cross-sectional view showing the structure of a magnetic sensor (single spin valve magnetoresistive element) of a fourth embodiment, which is viewed from a surface facing a recording medium;

FIG. 5 is a graph showing a product ΔR×A (mΩ·μm²) and a misfit percentage R as a function of the Fe composition x of Co₁₀₀₋ₓFeₓ (where x is represented by atomic percent), which is a material for an underlayer, the product ΔR×A being a product of the amount of change in resistance and an element surface area of a magnetic sensor, and the misfit percentage R being obtained from the d value b of a primary lattice line of a Co₁₀₀₋ₓFeₓ alloy layer (underlayer; 10 Å) and the d value b of a primary lattice line of a Co₂MnGe alloy layer (Heusler alloy layer; 40 Å) of a lower-side pinned magnetic layer, wherein the misfit percentage R=(a−b)×100/b (%);

FIG. 6 is a graph showing the relationship between the lattice constant and the saturation magnetization of a Co₂MnGe alloy layer;

FIG. 7 is a graph showing the relationship between the lattice constant and the saturation magnetization of a Co₂MnSi alloy layer;

FIG. 8 is a graph showing the change in product ΔR×A of the amount of change in resistance and an element surface area of a magnetic sensor as a function of magnetic film thickness Ms×t of the whole magnetic sensor;

FIG. 9 is a graph showing the change in product ΔR×A of the amount of change in resistance and an element surface area of a magnetic sensor as a function of the Ge composition of a Co₂MnGe alloy for a Heusler alloy layer of a second pinned magnetic layer; and

FIG. 10 is a cross-sectional view of the structure of a related magnetic sensor when viewed from a surface facing a recording medium.

### DETAILED DESCRIPTION

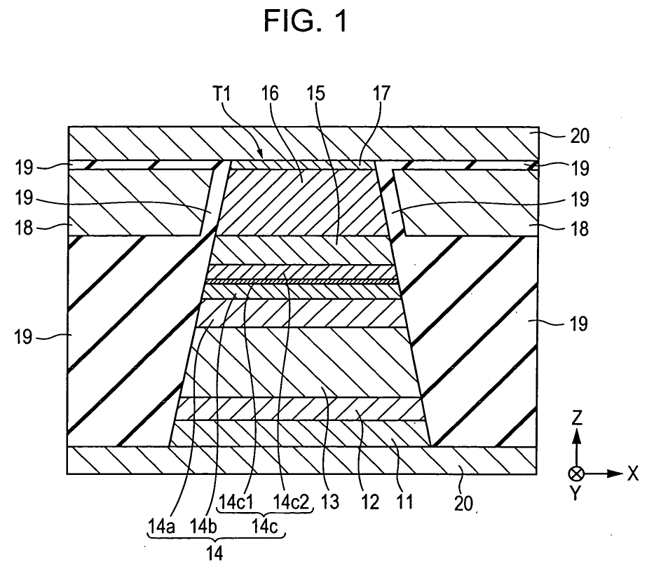

FIG. 1 is a cross-sectional view showing the whole structure of a magnetic sensor (single spin valve magnetoresistive element) of a first embodiment, which is viewed from a surface facing a recording medium. FIG. 1 shows a cross-section of a central portion of the element extending in the X direction.

This single spin valve magnetoresistive element is provided on a side end portion of a floating slider provided in a hard disk device in order to detect a recording magnetic field from a hard disk or the like. In FIG. 1, the traveling direction of the recording medium such as a hard disk is a Z direction, and the direction of a leakage magnetic field from the recording medium is a Y direction.

A layer formed at a lower-side position shown in FIG. 1 is an underlayer 11 of a non-magnetic material which includes at least one element selected from the group consisting of Ta, Hf, Nb, Zr, Ti, Mo, and W. On this underlayer 11, a seed layer 12, an antiferromagnetic layer 13, a pinned magnetic layer 14, a non-magnetic material layer 15, a free magnetic layer 16, and a protective layer 17 are provided in that order from the bottom to form a multilayer film T1. The magnetic sensor shown in FIG. 1 is a so-called bottom spin valve GMR magnetic sensor in which the antiferromagnetic layer 13 is provided under the free magnetic layer 16.

The seed layer 12 can be formed, for example, from NiFeCr or Cr. When formed from NiFeCr, the seed layer 12 has a face-centered cubic (fcc) structure, and equivalent crystal planes represented by the {111} family of planes are preferentially oriented in the direction parallel to the film surface. In addition, when formed from Cr, the seed layer 12 has a body-centered cubic (bcc) structure, and equivalent crystal planes represented by the {110} family of planes are preferentially oriented in the direction parallel to the film surface.

In addition, the underlayer 11 has a nearly amorphous structure and may not be formed in some cases.

The antiferromagnetic layer 13 provided on the seed layer 12 is preferably formed of an antiferromagnetic material containing Mn and an element X (where X is at least one element selected from the group consisting of Pt, Pd, Ir, Rh, Ru, and Os).

The antiferromagnetic layer 13 may have a face-centered cubic (fcc) structure or a face-centered tetragonal (fct) structure.

As an antiferromagnetic material, the above X—Mn alloy based on a platinum-group element has advantageous properties, such as superior corrosion resistance, a high blocking temperature, and the ability to increase an exchange coupling magnetic field (Hex). In particular, among the platinum-group elements, Pt may be used, and for example, a binary alloy such as a PtMn alloy may be used.

In addition, in the present embodiment, the antiferromagnetic layer 13 may be formed of an antiferromagnetic material containing Mn, the element X, and an element X′ (where X′ is at least one element selected from the group consisting of Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and a rare earth element).

As the element X′, it is preferable to use an element that occupies interstices of a space lattice made of Mn and the element X so as to form an interstitial solid solution or, alternatively, an element that replaces some of the lattice points of a crystal lattice made of Mn and the element X to form a substitutional solid solution. The solid solutions mentioned above represent solids in which the components thereof are uniformly mixed together in a broad concentration range.

When the interstitial solid solution or the substitutional solid solution is formed, the lattice constant of the X—Mn—X′ alloy can be increased compared to the lattice constant of the X—Mn alloy film. Accordingly, the difference between the lattice constant of the antiferromagnetic layer 13 and that of the pinned magnetic layer 14 can be increased, and as a result, the interface structure therebetween can be easily placed in a non-aligned state. In this embodiment, the non-aligned state indicates a state in which the atoms forming the antiferromagnetic layer 13 are not in one-to-one correspondence with the atoms forming the pinned magnetic layer 14 at the interface therebetween.

In particular, in the case in which the element X′ is used to form a substitutional solid solution, when the composition ratio of the element X′ is excessively increased, the antiferromagnetic properties are degraded, and as a result, the exchange coupling magnetic field generated at the interface with the pinned magnetic layer 14 is decreased. Accordingly, an interstitial solid solution may be formed, and a noble gas (at least one of Ne, Ar, Kr, and Xe), which is also called an inert gas, may be used as the element X′. Incorporation of a noble gas into the film does not significantly influence the antiferromagnetic properties. Ar or similar gases may be incorporated into the film by appropriately adjusting the gas pressure during sputter deposition.

When a gaseous element is used as the element X′, a large amount of the element X′ may not be easily incorporated into the film; however, in the case of a noble gas, even when a relatively small amount thereof is incorporated into the film, the exchange coupling magnetic field can be significantly increased by heat treatment.

The composition ratio of the element X′ is preferably 0.2 to 10 atomic percent, and, more preferably, 0.5 to 5 atomic percent. In addition, the element X may be Pt, and hence a Pt—Mn—X′ alloy may be used.

In addition, the composition ratio of the element X or that of the element X+X′ of the antiferromagnetic layer 13 may be set in the range of 45 to 60 atomic percent. More preferably, the range is set to 49 to 56.5 atomic percent. As a result, it is believed that the interface with the pinned magnetic layer 14 is placed in a non-aligned state during film deposition and that, upon heat treatment, an appropriate ordering transformation occurs in the antiferromagnetic layer 13.

The pinned magnetic layer 14 has a multilayer structure formed of a first pinned magnetic layer 14a, a non-magnetic interlayer 14b, and a second pinned magnetic layer 14c. The magnetization directions of the first and the second pinned magnetic layers 14a and 14c are antiparallel to each other by the exchange coupling magnetic field at the interface with the antiferromagnetic layer 13 and the antiferromagnetic exchange coupling magnetic field (RKKY interaction) between the first and the second pinned magnetic layers 14a and 14c with the non-magnetic interlayer 14b provided therebetween. This state is a so-called synthetic ferrimagnetic coupling state, which allows the magnetization of the pinned magnetic layer 14 to be stabilized, and in addition, an apparent exchange coupling magnetic field generated at the interface between the pinned magnetic layer 14 and the antiferromagnetic layer 13 to be increased.

However, the pinned magnetic layer 14 may be formed of the second pinned magnetic layer 14c so as not to be placed in a synthetic ferrimagnetic coupling state.

In addition, the first pinned magnetic layer 14a is formed to have a thickness of approximately 15 to 35 Å, the non-magnetic interlayer 14b is formed to have a thickness of approximately 8 to 10 Å, and the second pinned magnetic layer 14c is formed to have a thickness of approximately 20 to 50 Å.

The first pinned magnetic layer 14a is formed of a ferromagnetic material such as CoFe or NiFe. In addition, the non-magnetic interlayer 14b is formed of a non-magnetic conductive material such as Ru, Rh, Ir, Cr, Re, and Cu.

The second pinned magnetic layer 14c is a laminate of an underlayer 14c1 and a Heusler alloy layer (half-metal alloy layer) 14c2. In this embodiment, the underlayer 14c1 forming a part of the second pinned magnetic layer 14c is located at the non-magnetic interlayer 14b side.

The underlayer 14c1 has a body-centered cubic (bcc) structure and is formed of a CoFe alloy having a composition formula represented by Co₁₀₀₋ₓFeₓ (where x is in the range of about 25 to about 95 on an atomic percent basis).

Materials forming the Heusler alloy layer 14c2 will be described below by way of example.

1. A Metal Compound Having a Heusler's Crystal Structure Represented By a Composition Formula X₂YZ or XYZ

In this case, X is at least one element selected from the group consisting of Cu, Co, Ni, Rh, Pt, Au, Pd, Ir, Ru, Ag, Zn, Cd, and Fe, Y is at least one element selected from the group consisting of Mn, Fe, Ti, V, Zr, Nb, Hf, Ta, Cr, Co, and Ni, and Z is at least one element selected from the group consisting of Al, Sn, In, Sb, Ga, Si, Ge, Pb, and Zn.

2. A Metal Compound Having a Heusler's Crystal Structure Represented By a Composition Formula Co₂YZ

In this case, Y is at least one element selected from the group consisting of Mn, Fe, and Cr, and Z is at least one element selected from the group consisting of Al, Ga, Si, and Ge.

For example, a Co₂MnGaGe alloy, a Co₂MnAlSi alloy, a Co₂CrFeAl alloy, and a Co₂CrFeGa alloy may be used.

3. A Metal Compound Having a Composition Formula Represented By Co₂MnZ

In this case, the Z is Si or Ge.

For example, the Heusler alloy layer 14c2 may be formed of a metal compound having a composition formula represented by Co₂MnGe and that the lattice constant of the Heusler alloy 14c2 is in the range of about 5.7 to about 5.85 Å.

Alternatively, the Heusler alloy layer 14c2 may be formed of Co₂MnGe, and the Ge concentration of this Co₂MnGe alloy may be in the range of about 20 to about 30 atomic percent.

In addition, the Heusler alloy layer 14c2 may be formed of a metal compound having a composition formula represented by Co₂MnSi, and the lattice constant of the Heusler alloy layer 14c2 may be in the range of about 5.6 to about 5.75 Å.

In addition, the average crystal grain diameter of the Heusler alloy 14c2 in the direction parallel to the film surface thereof is preferably 50 Å or more and, more preferably, 100 Å or more. When the average crystal grain diameter is increased, the crystal grain boundary area is decreased, and as a result, the interface scattering of conduction electrons, which is independent of spin, may be decreased also.

Furthermore, the Heusler alloy layer 14c2 may have a body-centered cubic (bcc) structure, and equivalent crystal planes represented by the {220} family of planes may be preferentially oriented in the direction parallel to the film surface.

In addition, a misfit percentage R between the d value a of the primary lattice line of the Heusler alloy layer 14c2 and the d value b of the primary lattice line of the underlayer 14c1 may be in the range of 0% to 1.1%. In this case, the misfit percentage R=(a−b)×100/b (%) holds. When the misfit percentage R is within the range described above, the underlayer 14c1 may be formed using, for example, a CoFeNi alloy.

The non-magnetic material layer 15 provided on the pinned magnetic layer 14 is formed of Cu, Au, or Ag, for example. The non-magnetic material layer 15 has a face-centered cubic (fcc) structure, and equivalent crystal planes represented by the {111} family of planes are preferentially oriented in the direction parallel to the film surface.

Furthermore, the free magnetic layer 16 is formed. In this embodiment, the free magnetic layer 16 is formed of, for example, a NiFe alloy, a CoFe alloy, or the Heusler alloy described above.

In the embodiment shown in FIG. 1, the hard bias layers 18 are formed at the two sides of the free magnetic layer 16. The magnetization of the free magnetic layer 16 is aligned in the track width direction (X direction in the figure) by a longitudinal bias magnetic field from the hard bias layers 18. The hard bias layers 18 are formed, for example, of a Co—Pt (cobalt-platinum) alloy or a Co—Cr—Pt (cobalt-chromium-platinum) alloy.

The top, the bottom, and the end portion of each of the hard bias layers 18 are insulated by an insulating layer 19 formed of alumina or the like.

Electrode layers 20 are formed on the top and the bottom of the multilayer film T1, and a CPP (current perpendicular to the plane)-GMR magnetic sensor is formed in which a sensing current is allowed to flow in the direction perpendicular to the film surface of each of the layers forming the multilayer film T1.

The electrode layers 20 are formed, for example, of α-Ta, Au, Cr, Cu (copper), Rh, Ir, Ru, and W (tungsten).

In the spin valve thin-film element shown in FIG. 1, after the layers from the underlayer 11 to the protective layer 17 are formed as shown in the figure, a heat treatment is performed in order to generate an exchange coupling magnetic field at the interface between the antiferromagnetic layer 13 and the pinned magnetic layer 14. In this case, when the magnetization is aligned in the direction parallel to the Y direction in the figure, the magnetization of the pinned magnetic layer 14 is pinned in the direction parallel to the Y direction in the figure. In the embodiment shown in FIG. 1, since the pinned magnetic layer 14 has a laminated ferrimagnetic structure, when the first pinned magnetic layer 14a is magnetized, for example, in the Y direction in the figure, the second pinned magnetic layer 14c is magnetized in the direction opposite to the Y direction in the figure.

In addition, by the heat treatment described above, the structure of the Heusler alloy layer 14c2 of the pinned magnetic layer 14 may be controlled.

In the magnetic sensor shown in FIG. 1, the magnetization of the pinned magnetic layer and that of the free magnetic layer are perpendicular to each other. When a leakage magnetic field from the recording medium enters the magnetic sensor along the Y direction in the figure, the magnetization direction of the free magnetic layer is changed. The relationship between the new magnetization direction of the free magnetic layer and the pinned magnetization direction of the pinned magnetic layer determines the electrical resistance of the magnetic sensor. This change in electrical resistance can be measured as a change in voltage or current, and the leakage magnetic field from the recording medium is thereby detected.

When a CPP-GMR magnetic sensor has a Heusler alloy layer, the amount of change in the spin diffusion length or in the mean free path of a conduction electron before and after the application of an external magnetic field is increased. That is, the amount of change in resistance of the multilayer film is increased, and as a result, the detection sensitivity to an external magnetic field can be improved.

In the pinned magnetic layer 14, when the underlayer 14c1 is provided under the Heusler alloy layer 14c2, the product ΔR×A of the amount of change in resistance and the element surface area of the magnetic sensor is increased. That is, the detection sensitivity to an external magnetic field can be improved.

It is believed that the magnetic field detection sensitivity is improved because the misfit percentage between the underlayer 14c1 and the Heusler alloy layer 14c2 is small as described above, and therefore the crystallinity or the periodicity of the Heusler alloy layer 14c2 is improved.

In addition, it is known that when the lattice constant of the crystal of the Heusler alloy layer 14c2 has an appropriate value, the saturation magnetization Ms of the Heusler alloy layer 14c2 is increased, and thus the product ΔR×A of the amount of change in resistance and the element surface area of the magnetic sensor is increased.

In this embodiment, the free magnetic layer 16 is formed to have a single-layer structure. However, the free magnetic layer may be formed to have a multilayer structure. In addition, the free magnetic layer may be formed to have a synthetic ferrimagnetic structure in which a layer formed of a ferromagnetic material and a Heusler alloy layer are antiferromagnetically coupled by the RKKY interaction with a non-magnetic interlayer of a non-magnetic material interposed therebetween.

As shown in FIG. 1, the multilayer film T1 has a trapezoidal form in which the track width dimension is decreased toward the upper side. When the free magnetic layer 16 is located above the antiferromagnetic layer 13 and the pinned magnetic layer 14 as in the bottom spin valve magnetic sensor of this embodiment, the dimension of the free magnetic layer 16 in the track width direction (X direction in the figure), which defines the track width of the magnetic sensor, can be made smaller than that of a top spin valve magnetic sensor, which will be described later.

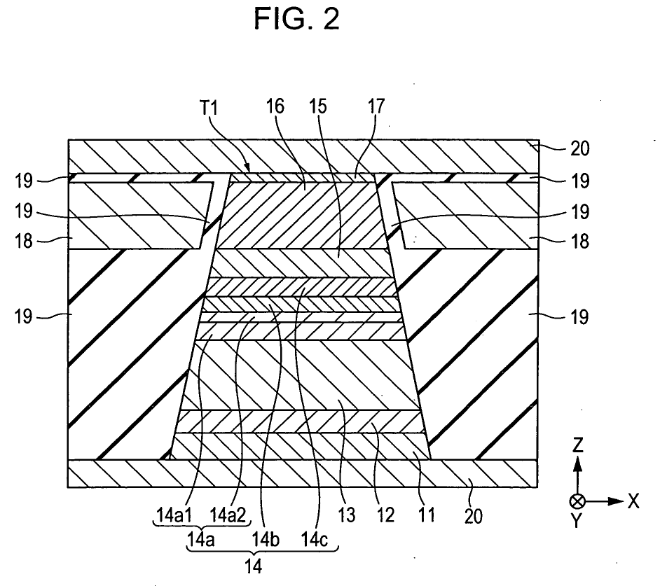

FIG. 2 is a partial cross-sectional view showing the structure of a single spin valve magnetic sensor of a second embodiment of the present invention.

The magnetic sensor shown in FIG. 2 has the same structure as that of the magnetic sensor shown in FIG. 1, except for the structure of the pinned magnetic layer 14. In the magnetic sensor shown in FIG. 2, the first pinned magnetic layer 14a of the pinned magnetic layer 14 is a laminate formed of a magnetic layer 14a1 and an underlayer 14a2, and the second pinned magnetic layer 14c is formed of a Heusler alloy layer (half-metal alloy layer). In this case, the second pinned magnetic layer 14c may be a laminate formed of a CoFe alloy layer and a Heusler alloy layer. The structures and materials of layers shown in FIG. 2 designated by the same reference numerals as those in FIG. 1 are the same as those in FIG. 1, and hence description thereof will be omitted.

In addition, the underlayer 14a2 of the first pinned magnetic layer 14a is formed of the same material as that of the underlayer 14c1 of the magnetic sensor shown in FIG. 1. The second pinned magnetic layer 14c, which is a Heusler alloy layer, is formed of the same material and has the same structure as that of the Heusler alloy layer 14c2 of the magnetic sensor shown in FIG. 1.

In this embodiment, above the underlayer 14a2, the second pinned magnetic layer 14c, which is a Heusler alloy layer, is provided with the non-magnetic interlayer 14b interposed therebetween.

In the magnetic sensor of this embodiment, the product ΔR×A of the amount of change in resistance and the element surface area of the magnetic sensor can be increased. That is, the magnetic field detection sensitivity of the magnetic sensor can be improved.

It is believed that the magnetic field detection sensitivity of the magnetic sensor is improved because the misfit percentage between the underlayer 14a2 and the second pinned magnetic layer (Heusler alloy layer) 14c is small, and therefore the crystallinity or the degree of order of the second pinned magnetic layer (Heusler alloy layer) 14c is improved.

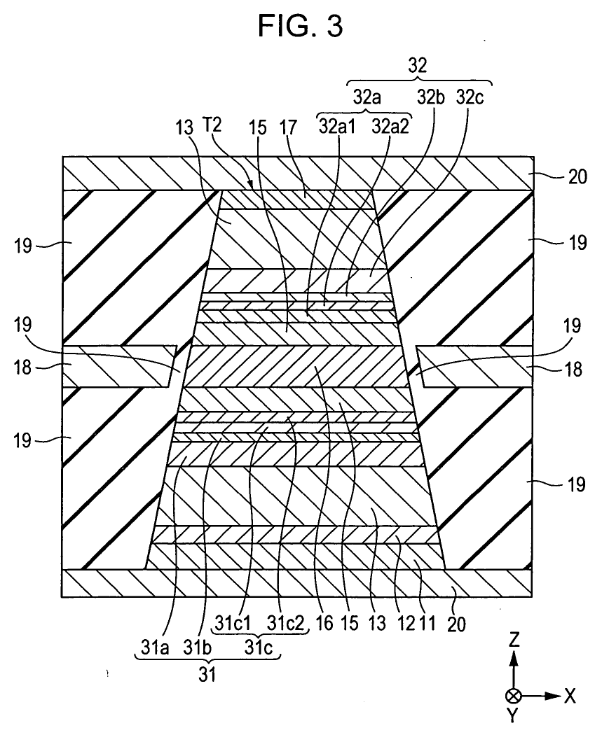

FIG. 3 is a partial cross-sectional view showing the structure of a dual spin valve magnetic sensor of the present invention.

As shown in FIG. 3, the underlayer 11, the seed layer 12, the antiferromagnetic layer 13, a pinned magnetic layer 31, the non-magnetic material layer 15, and the free magnetic layer 16 are formed in that order from the bottom. In addition, on the free magnetic layer 16, the non-magnetic material layer 15, a pinned magnetic layer 32, the antiferromagnetic layer 13, and the protective layer 17 are also formed in that order, so that a multilayer film T2 is formed.

In addition, at the two sides of the free magnetic layer 16, hard bias layers 18 are provided and are insulated by insulating layers 19 formed of alumina or the like.

Electrode layers 20 are provided on the top and the bottom of the multilayer film T2, so that a CPP (current perpendicular to the plane)-GMR magnetic sensor is formed in which a sensing current is allowed to flow in the direction perpendicular to the film surfaces of the individual layers forming the multilayer film T2.

In addition, the layers in FIG. 3 designated by the same reference numerals as those in FIG. 1 are formed of the same materials as those in FIG. 1.

The pinned magnetic layer 31 of the magnetic sensor shown in FIG. 3 has a structure in which a first pinned magnetic layer 31a, a non-magnetic interlayer 31b, and a second pinned magnetic layer 31c are laminated with each other. The first pinned magnetic layer 31a is formed of a ferromagnetic material such as CoFe.

The structure of the second pinned magnetic layer 31c includes a Heusler alloy layer (half-metal alloy layer) 31c2 on an underlayer 31c1. The underlayer 31c1 of the second pinned magnetic layer 31c is formed at the non-magnetic interlayer 31b side.

The underlayer 31c1 is formed of the same material and has the same structure as that of the underlayer 14c1 of the magnetic sensor shown in FIG. 1. In addition, the Heusler alloy layer 31c2 is formed of the same material and has the same structure as that of the Heusler alloy layer 14c2 of the magnetic sensor shown in FIG. 1. The Heusler alloy layer 31c2 has ferromagnetic properties, and, by ferromagnetic coupling, the underlayer 31c1 and the Heusler alloy layer 31c2 are magnetized in the same direction.

The magnetization direction of the first pinned magnetic layer 31a is antiparallel to that of the underlayer 31c1 and that of the Heusler alloy layer 31c2 by the exchange coupling magnetic field at the interface with the antiferromagnetic layer 13 described above and also by the antiferromagnetic exchange coupling magnetic field (RKKY interaction) between the first pinned magnetic layer 31a and the second pinned magnetic layer 31c, with the non-magnetic interlayer 31b interposed therebetween.

The pinned magnetic layer 32 of the magnetic sensor shown in FIG. 3 has a multilayer structure composed of a second pinned magnetic layer 32a, a non-magnetic interlayer 32b, and a first pinned magnetic layer 32c. The first pinned magnetic layer 32c is formed of a ferromagnetic material such as CoFe.

The structure of the second pinned magnetic layer 32a includes an underlayer 32a2 provided on a Heusler alloy layer (half-metal alloy layer) 32a1.

The underlayer 32a2 is formed of, for example, a CoFe alloy having a body-centered cubic (bcc) structure and a composition formula represented by Co₁₀₀₋ₓFeₓ (where x is in the range of about 25 to about 95 atomic percent). In addition, the misfit percentage R between the d value a of the primary lattice line of the Heusler alloy layer 32a1 and the d value b of the primary lattice line of the underlayer 32a2 is preferably in the range of 0% to 1.1%. In this embodiment, the underlayer 32a2 is provided on the Heusler alloy layer 32a1. Since the underlayer may be defined by the crystal structure and the composition thereof, or by the relationship with the Heusler alloy layer in terms of the misfit percentage, the underlayer is not always provided under the Heusler alloy layer.

In this embodiment, the underlayer 32a2 of the second pinned magnetic layer 32a is formed at the non-magnetic interlayer 32b side.

The underlayer 32a2 is formed of the same material and has the same structure as that of the underlayer 14c1 of the magnetic sensor shown in FIG. 1. In addition, the Heusler alloy layer 32a1 is formed of the same material and has the same structure as that of the Heusler alloy layer 14c2 of the magnetic sensor shown in FIG. 1. The Heusler alloy layer 32a1 has ferromagnetic properties, and the underlayer 32a2 and the Heusler alloy layer 32a1 are magnetized in the same direction by ferromagnetic coupling.

The magnetization direction of the first pinned magnetic layer 32c and that of the second pinned magnetic layer 32a are antiparallel to each other by the exchange coupling magnetic field at the interface with the antiferromagnetic layer 13 and the antiferromagnetic exchange coupling magnetic field (RKKY interaction) between the second and the first pinned magnetic layers 32a and 32c, with the non-magnetic interlayer 32b interposed therebetween.

In this embodiment, in the pinned magnetic layer 31, the underlayer 31c1 and the Heusler alloy layer 31c2 are laminated with each other, and in the pinned magnetic layer 32, the Heusler alloy layer 32a1 and the underlayer 32a2 are laminated with each other. With this structure, the product ΔR×A of the amount of change in resistance and the element surface area of the magnetic sensor is increased. That is, the magnetic field detection sensitivity of the magnetic sensor can be improved. When the underlayer 32a2 is provided on the Heusler alloy layer 32a1 in the pinned magnetic layer 32, the product ΔR×A of the amount of change in resistance and the element surface area of the magnetic sensor is also increased.

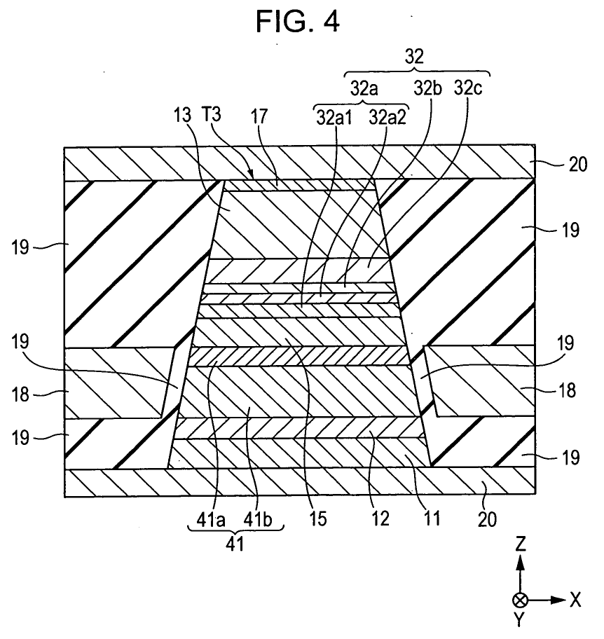

FIG. 4 is a partial cross-sectional view showing the structure of a top spin valve magnetic sensor.

As shown in FIG. 4, the underlayer 11, the seed layer 12, a free magnetic layer 41, the non-magnetic material layer 15, the pinned magnetic layer 32, the antiferromagnetic layer 13, and the protective layer 17 are formed in that order from the bottom, thereby forming a multilayer film T3.

In addition, at the two sides of the free magnetic layer 41, hard bias layers 18 are provided and are insulated by insulating layers 19 formed of alumina or the like.

Electrode layers 20 are provided on the top and the bottom of the multilayer film T3, so that a CPP (current perpendicular to the plane)-GMR magnetic sensor is formed in which a sensing current is allowed to flow in the direction perpendicular to the film surfaces of the individual layers forming the multilayer film T3.

In addition, the layers in FIG. 4 designated by the same reference numerals as those in FIGS. 1 and 2 are formed of the same materials as those in FIGS. 1 and 2.

In the magnetic sensor shown in FIG. 4, the free magnetic layer 41 has a two-layered structure having a first magnetic layer 41a made of, for example, NiFe and a second magnetic layer 41b made of, for example, CoFe, and this free magnetic layer 41 is provided on the seed layer 12 formed of, for example, NiFeCr or Cr.

When formed of NiFeCr, the seed layer 12 has a face-centered cubic (fcc) structure, and equivalent crystal planes represented by the {111} family of planes are preferentially oriented in the direction parallel to the film surface. In addition, when formed of Cr, the seed layer 12 has a body-centered cubic (bcc) structure, and equivalent crystal planes represented by the {110} family of planes are preferentially oriented in the direction parallel to the film surface.

In this embodiment, in the pinned magnetic layer 32, the Heusler alloy layer 32a1 and the underlayer 32a2 are laminated with each other. With this structure, the product ΔR×A of the amount of change in resistance and the element surface area of the magnetic sensor is increased. That is, the magnetic field detection sensitivity of the magnetic sensor can be improved. In the pinned magnetic layer 32, even when the underlayer 32a2 is provided on the Heusler alloy layer 32a1, the product ΔR×A of the amount of change in resistance and the element surface area of the magnetic sensor is increased.

In FIGS. 1 to 4, in the pinned magnetic layers 14, 31, and 32, the non-magnetic interlayers 14b, 31b, and 32b are each sandwiched by layers made of CoFe in the vertical direction in the figure. With this structure, the antiferromagnetic exchange coupling magnetic field (RKKY interaction) between the two magnetic layers with one of the non-magnetic interlayers 14b, 31b, and 32b interposed therebetween is increased.

### EXAMPLE 1

A CPP-GMR magnetic sensor (dual spin valve) having the following film structure was formed, where each value in the parentheses of the individual layers indicates the film thickness.

(Underlayer (Ta (30 Å))/seed layer ((Ni_{0.8}Fe_{0.2})₆₀Cr₄₀ (60 Å))/antiferromagnetic layer (IrMn (70 Å))/pinned magnetic layer (Co₉₀Fe₁₀(30 Å)/Ru (9 Å)/Co₁₀₀₋ₓFeₓ (10 Å)/Co₂MnGe (40 Å))/non-magnetic material layer (Cu (43 Å))/free magnetic layer (Co₂MnGe (80 Å))/non-magnetic material layer (Cu (43 Å))/pinned magnetic layer (Co₂MnGe (40 Å)/Co₉₀Fe₁₀ (10 Å)/Ru (9 Å)/Co₉₀Fe₁₀ (30 Å))/antiferromagnetic layer (IrMn (70 Å))/protective layer (Ta (30 Å))

The film structure of the lower-side pinned magnetic layer was (Co₉₀Fe₁₀ (30 Å)/Ru (9 Å)/Co₁₀₀₋ₓFeₓ (10 Å)/Co₂MnGe (40 Å)). A material for the underlayer provided under the Heusler alloy layer formed of Co₂MnGe was Co₁₀₀₋ₓFeₓ. The product ΔR×A (mΩ·μm²) and the misfit percentage R were measured as a function of the Fe composition x of this Co₁₀₀₋ₓFeₓ (where x indicates atomic percent) alloy, the product ΔR×A being the product of the amount of change in resistance and the element surface area of the magnetic sensor, and the misfit percentage R being obtained from the d value b of the primary lattice line of the Co₁₀₀₋ₓFeₓ alloy layer (underlayer; 10 Å) and the d value a of the primary lattice line of the Co₂MnGe alloy layer (Heusler alloy layer; 40 Å) of the lower-side pinned magnetic layer. The misfit percentage R is represented by R=(a−b)×100/b (%). In this embodiment, the d value a of the primary lattice line (220) of the Co₂MnGe alloy layer (Heusler alloy layer; 40 Å) was set to 2.0305 Å.

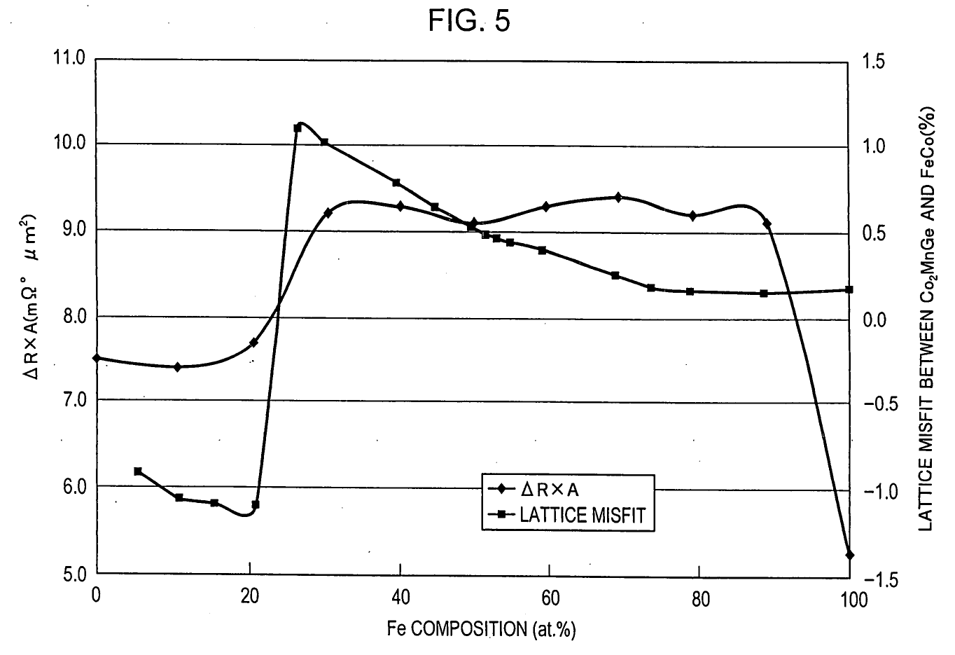

The result is shown in FIG. 5.

As can be seen from FIG. 5, when the Fe composition x of the Co₁₀₀₋ₓFeₓ alloy layer (where x indicates atomic percent) which is the underlayer provided under the Heusler alloy layer, is 25 atomic percent or more, the product ΔR×A of the amount of change in resistance and the element surface area of the magnetic sensor is significantly increased to 8.5 (mΩ·μm²) or more. When the Fe composition x is in the range of 30 to 90 atomic percent, the product ΔR×A of the magnetic sensor is more than 9 (mΩ·μm²).

One of the reasons the ΔR×A of the magnetic sensor is increased is that the Co₁₀₀₋ₓFeₓ alloy layer in the range described above has a body-centered cubic (bcc) structure which is the same crystal structure as that of Co₂MnGe forming the Heusler alloy layer.

In addition, when the Fe composition x of the Co₁₀₀₋ₓFeₓ alloy layer is 25 atomic percent or more, the misfit percentage R obtained from the d value b of the primary lattice line of the Co₁₀₀₋ₓFeₓ alloy layer (underlayer; 10 Å) and the d value a of the primary lattice line of the Co₂MnGe alloy layer (Heusler alloy layer; 40 Å) is controlled in the range of 0% to 1.1%. The misfit percentage R is controlled in the range of 0.16% to 1.1% when the Fe composition x of the Co₁₀₀₋ₓFeₓ alloy layer is 25 atomic percent or more.

From the result described above, the decrease in misfit percentage R described above, which is obtained from the crystal lattice of the underlayer and that of the Heusler alloy layer of the pinned magnetic layer, is one of the reasons the ΔR×A of the magnetic sensor of the present embodiment is increased.

It is believed that when the underlayer and the Heusler alloy layer of the pinned magnetic layer have the same crystal structure, and the misfit between the crystal lattices thereof is decreased, the crystallinity or the periodicity of the Heusler alloy layer is improved.

When the Fe composition x described above is more than 95%, the product ΔR×A of the amount of change in resistance and the element surface area of the magnetic sensor is decreased. The reason for this may be that the antiferromagnetic coupling caused by the RKKY interaction between the first pinned magnetic layer (Co₉₀Fe₁₀ (30 Å)) and the second pinned magnetic layer (Co₁₀₀₋ₓFeₓ (10 Å)/Co₂MnGe (40 Å)) of the pinned magnetic layer is decreased.

### EXAMPLE 2

A CPP-GMR magnetic sensor (dual spin valve) having the following film structure was formed. Each value in the parentheses of the individual layers indicates the film thickness.

(Underlayer (Ta (30 Å) )/seed layer ((Ni_{0.8}Fe_{0.2})₆₀Cr₄₀ (50 Å))/antiferromagnetic layer (IrMn (70 Å))/pinned magnetic layer (Co₇₀Fe₃₀ (30 Å)/Ru (9 Å)/Co₇₀Fe₃₀ (10 Å)/Co₂MnGe (40 Å))/non-magnetic material layer (Cu (43 Å) )/free magnetic layer (Co₂MnGe (80 Å))/non-magnetic material layer (Cu (43 Å))/pinned magnetic layer (Co₂MnGe (40 Å)/(Co₁₀₀₋ₓFeₓ (10 Å)/Ru (9 Å)/Co₇₀Fe₃₀ (30 Å))/antiferromagnetic layer (IrMn (70 Å))/protective layer (Ta (200 Å))

The film structure of the upper-side pinned magnetic layer was (Co₂MnGe (40 Å))/(Co₁₀₀₋ₓFeₓ (10 Å)/Ru (9 Å)/Co₇₀Fe₃₀ (30 Å))

In this example, the Co₁₀₀₋ₓFeₓ alloy layer provided on the Heusler alloy layer formed of Co₂MnGe corresponds to the underlayer. Since the underlayer is defined by the crystal structure and the composition thereof or by the relationship with the Heusler alloy layer in terms of misfit percentage, the underlayer is not always necessarily disposed under the Heusler alloy layer.

The product ΔR×A (mΩ·μm²) of the amount of change in resistance and the element surface area of the magnetic sensor was measured as a function of the Fe composition x of the Co₁₀₀₋ₓFeₓ alloy layer, which was the underlayer.

The result is shown in Table 1.

TABLE 1

| | Upper-side second | |
|---|---|---|
| | pinned magnetic layer | ΔR × A (mΩ · μm²) |
| Example 1 | Co₂MnGe (40 Å)/Co₇₀Fe₃₀ (10 Å) | 9.9 |
| Example 2 | Co₂MnGe (40 Å)/Co₄₀Fe₆₀ (10 Å) | 9.5 |
| Comparative | Co₂MnGe (40 Å)/Co₉₀Fe₁₀ (10 Å) | 8.7 |
| example | | |

As can be seen from Table 1, in examples 1 and 2 in which the Fe composition x of the Co₁₀₀₋ₓFeₓ alloy layer is in the range of about 25 to about 95 atomic percent, the product ΔR×A (mΩ·μm²) of the amount of change in resistance and the element surface area of the magnetic sensor is larger than that of the magnetic sensor of the comparative example. Hence, even when the underlayer, which is defined by the crystal structure and the composition thereof or by the relationship in terms of misfit percentage with the Heusler alloy layer, is provided on the Heusler alloy layer, the product ΔR×A (mΩ·μm²) of the amount of change in resistance and the element surface area of the magnetic sensor can be increased, so that the magnetic field detection sensitivity can be improved.

### EXAMPLE 3

A CPP-GMR magnetic sensor (single spin valve) having the following film structure was formed.

(Underlayer (Ta (30 Å))/seed layer (Cr (50 Å))/antiferromagnetic layer (PtMn (170 Å))/pinned magnetic layer (first pinned magnetic layer (30 Å)/Ru (9 Å)/second pinned magnetic layer (10 Å),(40 Å)/non-magnetic material layer (Cu (43 Å))/free magnetic layer (Co₂MnGe (80 Å)/Cu layer (10 Å)/Ta (30 Å))

Magnetic sensors were formed by changing the compositions of the first pinned magnetic layer (Pin 1) and the second pinned magnetic layer (Pin 2), and the magnetic properties thereof were measured.

The result is shown in Table 2.

TABLE 2

| | | | VSM (20 mm square) | | | | |
|---|---|---|---|---|---|---|---|
| | Pin 1 | Pin 2 (Å) | Ms · t (memu/cm²) | | | | |
| Sample No. | (Å) | *left side is Ru layer | Pin 1 | Pin 2-Total | Pin 2-Co₂MnSi | Free | SV-Total |
| Comparative | CoFe (30) | CoFe (10)/Co₂MnSi (40) | 0.31 | 0.29 | 0.17 | 0.29 | 0.89 |
| example | | | | | | | |
| Example 1 | CoFe (30) | 60FeCo (10)/Co₂MnSi | 0.32 | 0.49 | 0.32 | 0.28 | 1.08 |
| | | (40) | | | | | |
| Example 2 | 60FeCo (30) | CoFe (10)/Co₂MnSi (40) | 0.50 | 0.34 | 0.22 | 0.27 | 1.11 |
| Example 3 | 60FeCo (30) | 60FeCo (10)/Co₂MnSi | 0.50 | 0.50 | 0.33 | 0.28 | 1.28 |
| | | (40) | | | | | |

In Table 2, Pin 1 is the first pinned magnetic layer of the above magnetic sensor, and Pin 2 is the second pinned magnetic layer. The alloy represented by CoFe is a Co₉₀Fe₁₀ alloy, and the alloy represented by 60FeCo is a Fe₆₀Co₄₀ alloy. In addition, each value in the parentheses of the individual layers indicates the film thickness.

In the comparative example, the second pinned magnetic layer was a laminate of a Co₉₀Fe₁₀ alloy layer and a Co₂MnSi layer, and in example 1, the second pinned magnetic layer was a laminate of a Fe₆₀Co₄₀ alloy layer and a Co₂MnSi layer.

As can be seen from Table 2, the magnetic film thickness (Ms×t: product of saturation magnetization and film-thickness) of the Co₂MnSi layer (Pin 2-Co₂MnSi) of example 1 is 0.32 (memu/cm²) and is approximately two times the magnetic film thickness of the Co₂MnSi layer (Pin 2-Co₂MnSi) of the comparative example, which is 0.17 (memu/cm²). The result thus obtained indicates that the crystallinity or the periodicity of the Co₂MnSi layer of example 1 is improved as compared to that of the Co₂MnSi layer of the comparative example.

In addition, the magnetic film thickness of the Co₂MnSi layer (Pin 2-Co₂MnSi) of example 2 is 0.22 (memu/cm²) and is larger than 0.17 (memu/cm²) which is the magnetic film thickness of the Co₂MnSi layer (Pin 2-Co₂MnSi) of the comparative example; however, the magnetic film thickness of the Co₂MnSi layer (Pin 2-Co₂MnSi) of example 2 is not as large as that of example 1. From the result thus obtained, it is understood that when the Fe₆₀Co₄₀ alloy layer is provided under the Co₂MnSi layer of the second pinned magnetic layer so. as to be in direct contact therewith, the crystallinity or the periodicity of the Co₂MnSi layer can be further improved.

In addition, the magnetic film thicknesses (SV-Total) of the whole magnetic sensors of examples 1, 2, and 3 are each larger than the magnetic film thickness (SV-Total) of the whole magnetic sensor of the comparative example.

### EXAMPLE 4

A CPP-GMR magnetic sensor (dual spin valve) having the following film structure was formed. Each value in the parentheses of the individual layers indicates the film thickness.

(Underlayer (Ta (30 Å))/seed layer ((Ni_{0.8}Fe_{0.2})₆₀Cr₄₀ (50 Å))/antiferromagnetic layer (PtMn (170 Å))/pinned magnetic layer (first pinned magnetic layer (30 Å)/Ru (9 Å)/second pinned magnetic layer (10 Å),(40 Å))/non-magnetic material layer (Cu (43 Å))/free magnetic layer (Co₂MnGe (80 Å))/non-magnetic material layer (Cu (43 Å))/pinned magnetic layer (Co₂MnGe (40 Å)/(Co₉₀Fe₁₀ (10 Å)/Ru (9 Å)/Co₉₀Fe₁₀ (30Å))/antiferromagnetic layer (PtMn (170 Å)/protective layer (Ta (200 Å)

Magnetic sensors were formed by changing the compositions of the first pinned magnetic layer (Pin 1) and the second pinned magnetic layer (Pin 2), and the magnetic properties thereof were measured.

The result is shown in Table 3.

TABLE 3

| | | Lower side- | | Free | | Upper side-Pin 1 | |
|---|---|---|---|---|---|---|---|
| | | Pin 1 (Å) | Lower side-Pin 2 | (Å) | Upper side--Pin 2 | (Å) | ΔR × A |
| | Seed | *left side is | (Å) | *left side is | (Å) | *right side is | (mΩ · |
| | (Å) | PtMn layer | *left side is Ru layer | bottom side | *right side is Ru layer | PtMn layer | μm²) |
| Comparative | Ta (30)/ | CoFe (30) | CoFe (10)/Co₂MnGe (40) | Co₂MnGe (80) | Co₂MnGe (40)/CoFe (10) | CoFe (30) | 7.72 |
| example | NiFe36Cr (50) | | | | | | |
| Example 1 | ↑ | CoFe (20)/ | CoFe (10)/Co₂MnGe (40) | Co₂MnGe (80) | Co₂MnGe (40)/CoFe (10) | CoFe (30) | 7.90 |
| | | 60FeCo (10) | | | | | |
| Example 2 | ↑ | CoFe (30) | 60FeCo (10)/Co₂MnGe | Co₂MnGe (80) | Co₂MnGe (40)/CoFe (10) | CoFe (30) | 7.99 |
| | | | (40) | | | | |

In Table 3, Pin 1 is the first pinned magnetic layer of the magnetic sensor, and Pin 2 is the second pinned magnetic layer. The alloy represented by CoFe is a Co₉₀Fe₁₀ alloy, and the alloy represented by 60FeCo is a Fe₆₀Co₄₀ alloy.

In example 1 in which the first pinned magnetic layer at the Ru layer side is formed of a Fe₆₀Co₄₀ alloy layer, the product ΔR×A of the amount of change in resistance and the element surface area of the magnetic sensor is larger than that of the magnetic sensor of the comparative example. In example 2 in which the second pinned magnetic layer is a laminate of a Fe₆₀Co₄₀ alloy layer and a Co₂MnGe layer, the product ΔR×A of the amount of change in resistance and the element surface area of the magnetic sensor is larger than that of the magnetic sensor in example 1.

### EXAMPLE 5

An improvement in the product ΔR×A of the amount of change in resistance and the element surface area may be achieved by appropriately adjusting the misfit percentage R between the d value b of the primary lattice line of a Co₁₀₀₋ₓFeₓ alloy layer (underlayer; 10 Å) of the pinned magnetic layer and the d value a of the primary lattice line of a Co₂MnGe alloy layer (Heusler alloy layer; 40 Å) thereof.

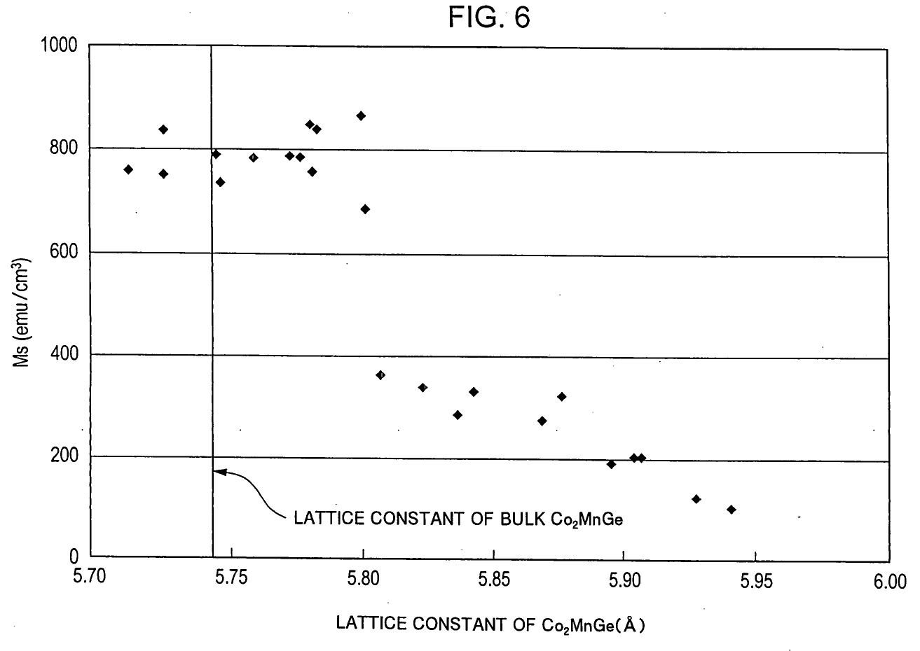

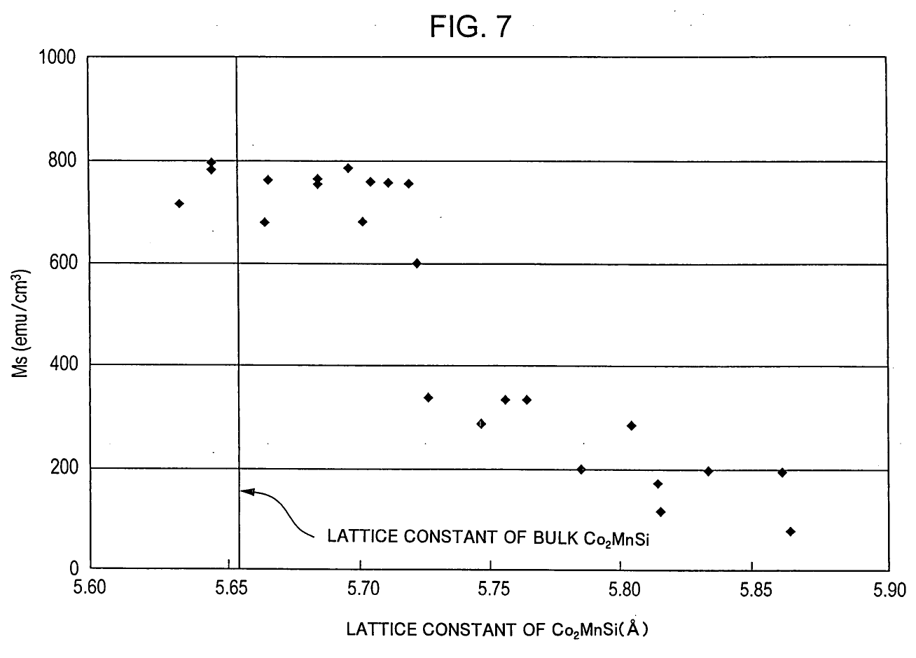

FIG. 6 is a graph showing the relationship between the lattice constant and the saturation magnetization Ms of the Co₂MnGe film, and FIG. 7 is a graph showing the relationship between the lattice constant and the saturation magnetization Ms of the Co₂MnSi film.

A single Co₂MnGe film and a single Co₂MnSi film, each having a thickness of 1,000 Å, were formed by sputtering.

The lattice constant of the Co₂MnGe film and that of the Co₂MnSi film may depend on any heat treatments performed, the composition ratio of the films, and the composition of underlayers located under the Co₂MnGe film and the Co₂MnSi film.

In this example, the Co₂MnGe film and the Co₂MnSi film each were processed by heat treatment at 290, 350, and 400° C. When the heat treatment temperature was increased, the lattice constant of the Co₂MnGe film and that of the Co₂MnSi film decreased.

As can be seen from FIGS. 6 and 7, as the lattice constant of the Co₂MnGe film and that of the Co₂MnSi film are decreased, the saturation magnetizations thereof increase. When the Co₂MnGe film have a lattice constant of 5.80 Å or less, the saturation magnetization rapidly increases. It is believed that when the lattice constant of the Co₂MnGe film is more than 5.80 Å, an amorphous-like crystal structure is formed, and that when the lattice constant is 5.80 Å or less, the crystallinity or the periodicity is improved, and thus the saturation magnetization is increased. In addition, in the case of the Co₂MnSi film, when the lattice constant is 5.72 Å or less, the saturation magnetization rapidly increases.

In addition, when the lattice constant of the Co₂MnGe film and that of the Co₂MnSi film are each in the range of approximately ±0.05 Å of the lattice constant thereof in a bulk state, the saturation magnetization is increased.

A CPP-GMR magnetic sensor having the following film structure was formed. Each value in the parentheses of the individual layers indicates the film thickness.

(Underlayer (Ta (30 Å))/seed layer ((Ni_{0.8}Fe_{0.2})₆₀Cr₄₀ (50 Å))/antiferromagnetic layer (PtMn (170 Å))/pinned magnetic layer (Co₉₀Fe₁₀ (30 Å)/Ru (9 Å)/Co₉₀Fe₁₀ (10 Å)/Co₂MnGe (40 Å))/non-magnetic material layer (Cu (43 Å))/free magnetic layer (Co₂MnGe (80 Å))/non-magnetic material layer (Cu (43 Å))/pinned magnetic layer (Co₂MnGe (40 Å)/Co₉₀ Fe₁₀ (10 Å)/Ru (9 Å)/Co₉₀Fe₁₀ (30 Å))/antiferromagnetic layer (PtMn (170 Å))/protective layer (Ta (200 Å))

Further, the magnetic film thickness Ms×t of the whole magnetic sensor was varied by changing the magnetic film thickness Ms×t of the pinned magnetic layer and that of the free magnetic layer, and the corresponding change in the product ΔR×A of the amount of change in resistance and the element surface area was investigated.

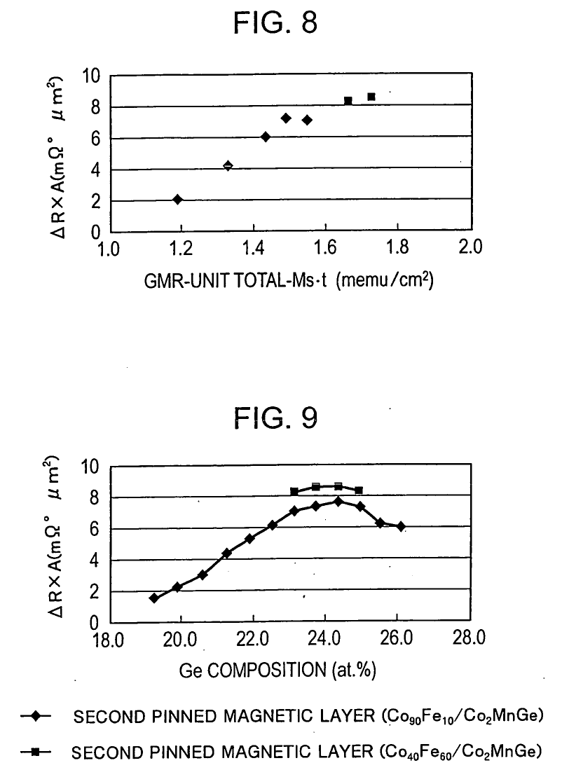

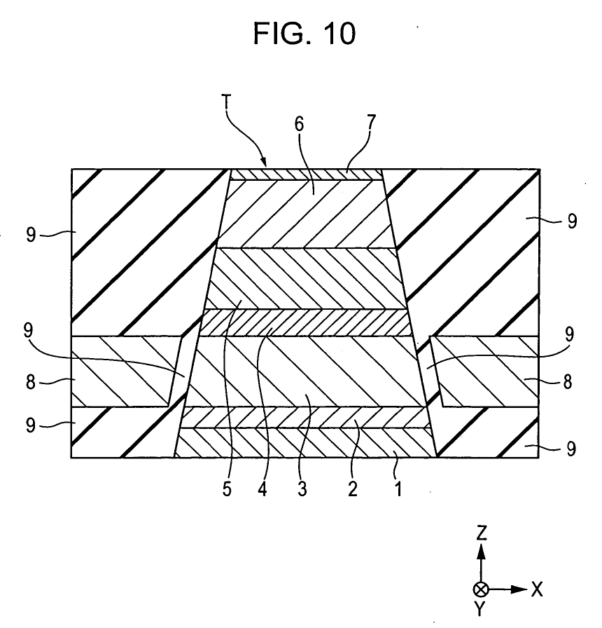

The result is shown in FIG. 8. As can be seen from FIG. 8, when the magnetic film thickness Ms×t of the whole magnetic sensor is increased, the product ΔR×A of the amount of change in resistance and the element surface area is increased, and hence the magnetic field detection sensitivity of the magnetic sensor is improved.

Accordingly, a Heusler alloy layer having a lattice constant in the range in which the saturation magnetization Ms is increased is preferably used for forming the pinned magnetic layer.

The misfit percentage R is defined by R=(a−b)×100/b (%) when the d value of the primary lattice line of the Heusler alloy layer and that of the underlayer are represented by a and b, respectively. When the misfit percentage R is decreased, the alignment between the crystal lattice of the underlayer and that of the Heusler alloy layer of the pinned magnetic layer is improved.

In example 1 (FIG. 5), it is believed that when the misfit percentage R is negative, the d value of the underlayer (CoFe alloy layer) is larger than 2.0305 Å, which is an ideal d value of the Heusler alloy layer, and the actual lattice constant thereof is increased. As a result, the saturation magnetization Ms is decreased.

It is also believed that when the misfit percentage R is in the range of approximately 0% to 1.1%, the lattice constant of the Heusler alloy layer is close to the ideal value, and as a result, the saturation magnetization Ms is increased.

Since the lattice constant of the Heusler alloy layer forming the pinned magnetic layer can be controlled in an appropriate range, it is believed that the magnetic film thickness Ms×t of the pinned magnetic layer and that of the whole magnetic sensor are increased and the product ΔR×A of the amount of change in resistance and the element surface area is increased. As a result, the magnetic field detection sensitivity of the magnetic sensor is improved.

### EXAMPLE 6

A CPP-GMR magnetic sensor was formed. [MR1]Further, the product ΔR×A of the amount of change in resistance and the element surface area was investigated as a function of the Ge composition of a Co₂MnGe alloy, which was a material for the Heusler alloy layer of the second pinned magnetic layer.

The result is shown in FIG. 9.

As can be seen from FIG. 9, when the Ge concentration of the Co₂MnGe alloy layer is in the range of about 22 to about 26 atomic percent, the product ΔR×A (mΩ·μm²) is preferably 5 (mΩ·μm²) or more.

In the magnetic sensor in which the underlayer of the second pinned magnetic layer is formed of Co₄₀Fe₆₀, the product ΔR×A is always large as compared to that of the magnetic sensor in which the underlayer is formed of Co₉₀Fe₁₀.

Heretofore, the present invention has been described with reference to various examples; however, the present invention may be variously modified or changed without departing from the spirit and the scope of the present invention. For example, the present invention may be applied to a CPP-TMR (tunnel effect magnetoresistive element) or a CIP (current in the plane)-GMR magnetic sensor in which electrode layers are formed at two sides of a magnetic sensor in the horizontal direction, and in which a sensing current is allowed to flow in the direction parallel to surfaces of films forming the magnetic sensor.

In addition, the above examples were described by way of example, and it is naturally to be understood that the present invention is not limited thereto and is limited only by the claims.

1. A magnetic sensor comprising:
a pinned magnetic layer;
a free magnetic layer; and
a non-magnetic material layer interposed between the pinned magnetic layer and the free magnetic layer,
wherein the pinned magnetic layer comprises an underlayer and a half-metal alloy layer, and
wherein the underlayer comprises a CoFe alloy layer having a body-centered cubic (bcc) structure and a composition formula represented by Co₁₀₀₋ₓFeₓ (where x is in the range of about 25 to about 95 atomic percent).

2. The magnetic sensor according to claim 1, wherein a layer of a non-magnetic material is disposed between the underlayer and the half-metal layer.

3. The magnetic sensor according to claim 1, wherein a layer of a magnetic material is disposed between the underlayer and the half-metal layer.

4. The magnetic sensor according to claim 1, wherein the half-metal alloy layer has a body-centered cubic (bcc) structure in which equivalent planes represented by the {220} family of planes are preferentially oriented in the direction parallel to a surface of the layer.

5. The magnetic sensor according to claim 1, wherein the pinned magnetic layer has a synthetic ferrimagnetic structure comprising a first pinned magnetic layer, a second pinned magnetic layer, and a non-magnetic interlayer interposed therebetween, wherein the underlayer and the half-metal alloy layer form the second pinned magnetic layer, and the underlayer is located facing the non-magnetic interlayer.

6. The magnetic sensor according to claim 1, wherein the pinned magnetic layer has a synthetic ferrimagnetic structure formed of a first pinned magnetic layer, a second pinned magnetic layer, and a non-magnetic interlayer interposed therebetween, wherein the underlayer forms a part of the first pinned magnetic layer and is located facing the non-magnetic interlayer, and the half-metal alloy layer forms the second pinned magnetic layer.

7. The magnetic sensor according to claim 1, wherein the half-metal alloy layer has an average crystal grain diameter of 50 Å or more in the direction parallel to a surface of the layer.

8. The magnetic sensor according to claim 1, wherein the half-metal alloy layer is a Heusler alloy layer.

9. The magnetic sensor according to claim 8,
wherein the Heusler alloy layer comprises a metal compound having a Heusler's crystal structure which has a composition formula represented by X₂YZ or XYZ, and
wherein the X is at least one element selected from the group consisting of Cu, Co, Ni, Rh, Pt, Au, Pd, Ir, Ru, Ag, Zn, Cd, and Fe, the Y is at least one element selected from the group consisting of Mn, Fe, Ti, V, Zr, Nb, Hf, Ta, Cr, Co, and Ni, and the Z is at least one element selected from the group consisting of Al, Sn, In, Sb, Ga, Si, Ge, Pb, and Zn.

10. The magnetic sensor according to claim 8,
wherein the Heusler alloy layer comprises a metal compound having a Heusler's crystal structure which has a composition formula represented by Co₂YZ, and
wherein the Y is at least one element selected from the group consisting of Mn, Fe, and Cr, and the Z is at least one element selected from the group consisting of Al, Ga, Si, and Ge.

11. The magnetic sensor according to claim 9, wherein the Heusler alloy layer comprises a metal compound having a composition formula represented by Co₂MnZ, and wherein the Z is Si or Ge.

12. The magnetic sensor according to claim 9, wherein the Heusler alloy layer comprises a metal compound having a composition formula represented by Co₂MnGe, and the lattice constant of the Heusler alloy layer is in the range of about 5.7 to about 5.85 Å.

13. The magnetic sensor according to claim 12, wherein the Co₂MnGe has a Ge concentration in the range of about 20 to about 30 atomic percent.

14. The magnetic sensor according to claim 10, wherein the Heusler alloy layer has a lattice constant of in the range of about 5.6 to about 5.75 Å.

15. The magnetic sensor according to claim 1, further comprising an antiferromagnetic layer, wherein the pinned magnetic layer is in contact with the antiferromagnetic layer.

16. The magnetic sensor according to claim 1, wherein the non-magnetic layer comprises a first non-magnetic layer and a second non-magnetic layer, and the first non-magnetic material layer is provided on a top surface of the free magnetic layer and the second non-magnetic layer provided on a bottom surface of the free magnetic layer, and the pinned magnetic layer comprises a first layer and a second layer; the first layer is provided on an opposite surface of the first non-magnetic layer from the free magnetic layer and the second layer is provided on an opposite surface-of the second non-magnetic surface from the free magnetic layer.

17. The magnetic sensor according to claim 16, further comprising a first antiferromagnetic layer and a second antiferromagnetic layer, wherein the first antiferromagnetic layer is disposed on an opposite side of the first layer from the first non-magnetic layer and the second antiferromagnetic layer is disposed on an opposite side of the second layer from the second non-magnetic layer.

18. The magnetic sensor according to claim 1, wherein a sensing current flow path is oriented in the direction perpendicular to surfaces of the pinned magnetic layer, the non-magnetic material layer, and the free magnetic layer.

19. A magnetic sensor comprising:
a pinned magnetic layer;
a free magnetic layer; and
a non-magnetic material layer interposed between the pinned magnetic layer and the free magnetic layer,
wherein the pinned magnetic layer comprises an underlayer and a half-metal layer, and
a misfit percentage R between a first spacing value (a) of a primary lattice line of the half-metal layer and a second spacing value (b) of a primary lattice line of the underlayer is in the range of about 0% to about 1.1%, the misfit percentage R being represented by R=(a−b)×100/b (%).

20. The magnetic sensor according to claim 19, wherein a layer of a non-magnetic material is disposed between the underlayer and the half-metal layer.

21. The magnetic sensor according to claim 19, wherein a layer of a magnetic material is disposed between the underlayer layer and the half-metal layer.

22. The magnetic sensor according to claim 19, wherein the underlayer comprises a CoFe alloy having a body-centered cubic (bcc) structure.

23. The magnetic sensor according to claim 19, wherein the underlayer comprises Co₁₀₀₋ₓFeₓ in which x is in the range of about 25 to about 95 atomic percent.
